(19) United States
(12) Patent Application Publication
(10) Pub. No.: US 2011/0292647 A1
(43) Pub. Date: Dec. 1, 2011

(54) LED TUBE LAMP

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/070,449

(22) Filed: Mar. 23, 2011

(30) Foreign Application Priority Data
May 28, 2010 (CN) 201010186113.7

(51) Int. Cl. F21V 29/00

(52) U.S. Cl. 362/218

(57) ABSTRACT

A LED tube lamp includes a hollow heat sink, a cover fixed on the hollow heat sink, at least two LED substrates mounted on the hollow heat sink, a pair of connectors configured to connect to a coupling connector to electrically connect the LED tube lamp to a power source, and a driving circuit contained in the hollow heat sink. Each of the at least two LED substrates emit light in a different direction, enlarging the light divergence angle of the LED tube lamp.

### BACKGROUND

1. Technical Field

The present disclosure relates to light emitting diode (LED) illuminating devices and, particularly, to an LED tube lamp.

2. Description of Related Art

Compared to traditional light sources, light emitting diodes (LEDs) have advantages, such as high luminous efficiency, low power consumption, and long service life. LED lights are widely used in many applications to replace typical fluorescent lamps and neon tube lamps.

Typical LED tube lamps usually include a cylindrical tube and an LED substrate. However, in order to increase the illuminance, a type of LED array including a plurality of LEDs connected in series arranged on the LED substrate is used in LED tube lamps. But all the LEDs in the LED array emit light in the same direction. This kind of LED array thus has no effect to increase light divergence angle of LED tube lamps.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of an LED tube lamp in accordance with an exemplary embodiment.

FIG. 2 is a cross-sectional view of the LED tube lamp of FIG. 1, taken along line II-II.

FIG. 3 is a diagram showing the radiation pattern of the LED tube lamp of FIG. 1 and a typical fluorescent tube lamp

### DETAILED DESCRIPTION

Embodiments of the present disclosure are now described in detail, with reference to the accompanying drawings.

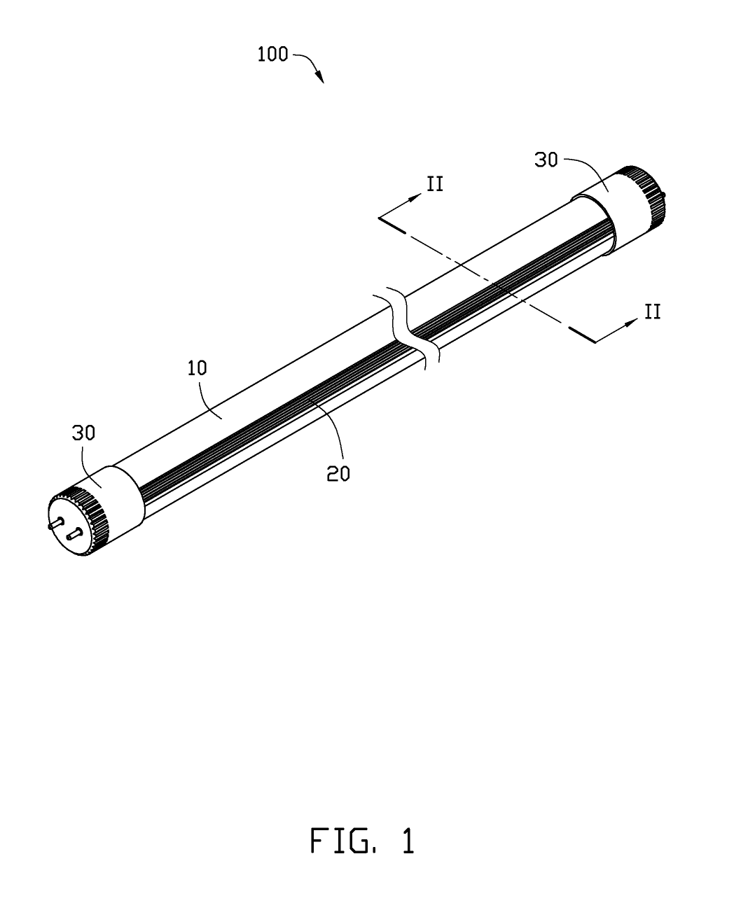

Referring to FIG. 1, an embodiment of an LED tube lamp 100 is illustrated. The LED tube lamp 100 includes a hollow heat sink 10, a cover 20, and a pair of connectors 30. The cover 20 is fixed to the heat sink 10, and has an elongated structure and is arc-shaped in cross section. The connectors 30 are arranged at opposite ends of the LED tube lamp 100 and are used to connect to a coupling connector (not shown), thus electrically connecting the LED tube lamp 100 to a power source.

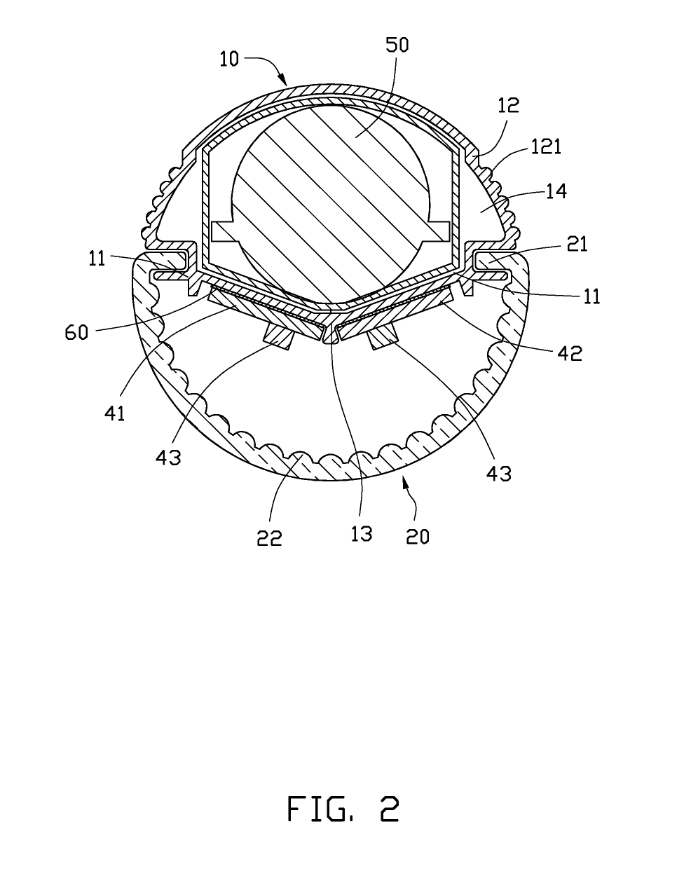

Referring to FIG. 2, the LED tube lamp 100 further includes a first LED substrate 41, a second LED substrate 42, and a driving circuit 50. The driving circuit 50 is arranged in the heat sink 10, and electrically connected to the connector 30, the first LED substrate 41, and the second LED substrate 42. The driving circuit 50 includes an AC/DC rectifier configured to convert alternating current to direct current delivered by the connector 30. A number of LEDs 43 are arranged on the first LED substrate 41 and the second LED substrate 42. The LEDs 43 can be chosen for having a large light divergence angle, high illuminance, and/or being colored according to actual requirements.

The heat sink 10 includes two connecting portions 11, a cooling wall 12, and a bottom portion 13. In the embodiment, the connecting portions 11 are grooves. A space 14 is formed between the cooling wall 12 and the bottom portion 13 for accommodating the driving circuit 50. The cooling wall 12 is made of metal with high heat conductivity, such as copper or aluminum. The cooling wall 12 includes a number of cooling fins 121 arranged on its outside to increase the heat dissipation area. The cover 20 includes two projecting members 21 extending inwardly from the opposite ends of the cover 20. The projecting members 21 are respectively received in the connecting portions 11, thus fixing the cover 20 to the heat sink 10.

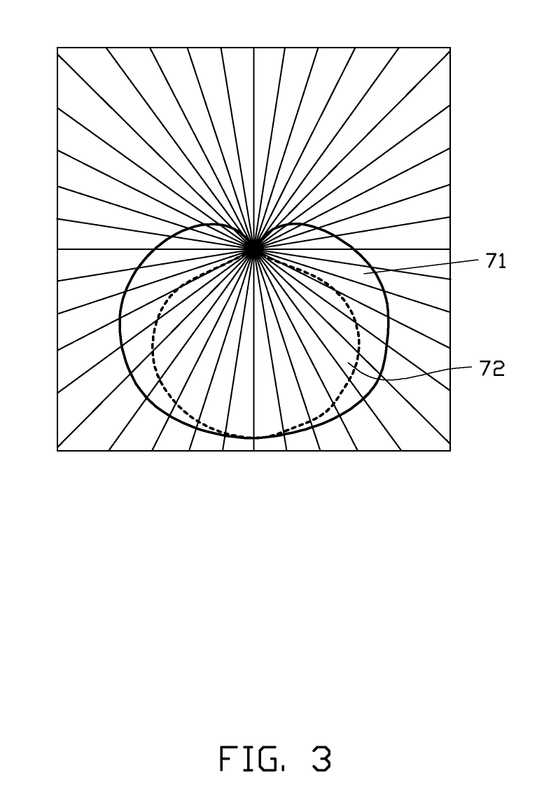

The first LED substrate 41 and the second LED substrate 42 are mounted on the outside surface of the bottom portion 13, and form an included angle. The angle between the prolongations of the lighting direction of the LEDs on the first LED substrate 41 and the second LED substrate 42 range from 0 degrees to about 180 degrees. The lighting direction of the first LED substrate 41 and the second LED substrate 42 are not parallel to each other. In other words, the first LED substrate 41 and the second LED substrate 42 emit light in different direction, thus enlarging the light divergence angle of the LED tube lamp 100. Referring to FIG. 3, as can be seen in the diagram, the first region 71 shows the radiation pattern of the LED tube lamp 100 in this embodiment, and the second region 72 shows the radiation pattern of a typical LED tube lamp. Obviously, the light divergence angle of the LED tube lamp 100 is greater than that of the existing LED tube lamp.

In this embodiment, the angle between the prolongations of the lighting direction of the LEDs on the first LED substrate 41 and the second LED substrate 42 is between 60 degrees and 170 degrees. The shape of the bottom portion 13 is determined according to the angle between the prolongations of the lighting direction of the LEDs secured on the first LED substrate 41 and the second LED substrate 42.

In this embodiment, the first LED substrate 41 and the second LED substrate 42 are fixed on the bottom portion 13 by fastening means, such as screws. A heat-conductive medium 60 can be arranged between the first LED substrate 41, the second LED substrate 42 and the top surface of the bottom portion 13, for transferring the heat generated by the LEDs 43 from the first LED substrate 41 and the second LED substrate 42 to the bottom portion 13, and then to the cooling wall 12. In this embodiment, the heat-conductive medium 60 can be thermal conductive glue or heat-conductive plate.

The cover 20 can be made of transparent or translucent material mixed with light diffusion particles to improve the light scattering effect of the light. In this embodiment, a plurality of accentuated portions 22 such as protuberances and/or recesses are defined on the internal surface of the cover 20. The light beams which enter the cover 20 are scattered by the accentuated portions 22.

In another embodiment, the LED tube lamp includes more than two LED substrates fixed on the bottom portion, and each LED substrate emits light in a different direction, enlarging the light divergence angle of the LED tube lamp.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED tube lamp, comprising:
a hollow heat sink;
at least two LED substrates mounted on the hollow heat sink and comprising a plurality of LEDs;
a cover fixed to the hollow heat sink, and covering the plurality of LEDs;
a pair of connectors configured to connect with a coupling connector to electrically connect the LED tube lamp to a power source;
a driving circuit accommodated in the hollow heat sink;
wherein the at least two LED substrates emit light in different direction.

2. The LED tube lamp according to claim 1, wherein the number of the at least two LED substrates is two, and a angle between the prolongations of the lighting direction of the two LED substrates range from 0 degrees to about 180 degrees.

3. The LED tube lamp according to claim 2, wherein the angle between the prolongations of the lighting direction of the two LED substrates range from about 60 degrees to 170 degrees.

4. The LED tube lamp according to claim 2, wherein the hollow heat sink further comprises a bottom portion, the two LED substrates are mounted on the outside surface of the bottom portion.

5. The LED tube lamp according to claim 1, wherein the at least two LED substrates are fixed to the hollow heat sink by fastening means, and a heat-conductive medium is arranged between the at least two LED substrates and the top surface of the hollow heat sink.

6. The LED tube lamp according to claim 1, wherein the hollow heat sink defines two grooves, the cover comprises two projecting members extending inwardly from the opposite ends of the cover, the two projecting members are respectively received in the grooves.

7. The LED tube lamp according to claim 1, wherein a plurality of cooling fins are arranged on the outside surface of the hollow heat sink.

8. The LED tube lamp according to claim 1, wherein the driving circuit comprises an AC/DC rectifier configured to convert alternating current to direct current delivered by the connector.

9. The LED tube lamp according to claim 1, wherein the cover is made of transparent or translucent material mixed with light diffusion particles.

10. The LED tube lamp according to claim 1, wherein plurality of accentuated portions are defined on the internal surface of the cover.
